(19) United States
(12) Patent Application Publication
(10) Pub. No.: US 2015/0202765 A1
(43) Pub. Date: Jul. 23, 2015

(54) STIR STICK HANDLE

(71) Applicant: Michael Paternostro, Plainsboro, NJ (US)

(72) Inventor: Michael Paternostro, Plainsboro, NJ (US)

(21) Appl. No.: 14/271,125

(22) Filed: May 6, 2014

Related U.S. Application Data
(60) Provisional application No. 61/821,601, filed on May 9, 2013.

(51) Int. Cl. B25G 1/00; A45F 5/10; B01F 15/00

(52) U.S. Cl. CPC B25G 1/00; B01F 15/00; A45F 5/10

(57) ABSTRACT

Wooden paint stirring sticks provided to consumers by retail stores are not ergonomic and are difficult to hold. The present invention is a reusable handle or grip for wooden paint stifling sticks which is ergonomic and inexpensive to manufacture. The present invention may be of one piece molded construction and formed with an internal chamber adapted to receive the end of a wooden stir stick and hold it therein by friction fit. The present invention may also serve as a handle for a bail on a paint can through the implementation of a transverse groove formed on its exterior surface. The present invention's shape also allows the wooden paint stir stick to lie flat (when inserted into the present invention) on a support surface with the stick above the surface so that it will not stick to the support surface when covered with paint.

### BACKGROUND OF THE INVENTION

1. Field of the Invention

The present invention relates to a reusable handle or grip for a paint stirring stick.

Manual devices for stirring paint or other liquid materials are frequently provided to consumers by retail stores for mixing paint or other liquids prior to use. Such stirring devices typically consist of a wooden or plastic stick like device that is of a flat elongated rectangular shape which often has arcuate recesses in its side edges near one end to facilitate manual gripping of the stick during use.

Stirring sticks of the type described above are inexpensive to make but are not convenient to use as the relatively thin flat shape of the stick is not ergonomic and is difficult to hold. Because such sticks typically are given away by retailers for single use purposes, in order to keep them inexpensive to manufacture, they have not been made more complex or convenient to use.

### SUMMARY OF THE INVENTION

It is an object of the invention to provide a reusable handle for a paint stirrer stick.

Another object of the invention is to provide a reusable handle for a stirring stick which is ergonomic and inexpensive to manufacture.

Yet another object of the invention is to provide a reusable handle for a stirring stick which may also serve as the handle for a bail on a can or the like.

The present invention provides a reusable handle for conventional paint stirring sticks which is ergonomically shaped. In addition the handle is shaped to serve a supplemental purpose as a carrier handle for the bail of a paint can, and optionally, is provided with an aperture which allows the handle, with or without the stick to be hung on a hook for storage.

The handle of the present invention may be of one piece molded construction. The handle is formed with an internal chamber adapted to receive the end of a stirring stick and hold it therein by friction fit.

The handle also may have a transverse groove formed on its exterior surface generally transverse to its length which is adapted to receive the bail of a can or the like to form a convenient and comfortable handle with which to transmit the can.

The above and other objects, features and advantages of the present invention will be apparent to those skilled in the art from the following detailed description thereof when read in connection with the accompanying drawings, wherein:

### BRIEF DESCRIPTION OF THE DRAWINGS

FIG. 1 is a perspective view of the stir stick handle of the present invention in position engaging the bail of a paint can for transport;

FIG. 2 is an elevational view of the device as shown in FIG. 1;

FIG. 3 is a perspective view of the stir stick handle of the invention alone;

FIG. 4 is a plan view of the device of FIG. 2;

FIG. 5 is an end view of the device illustrating the opening therein through which a stir stick is inserted into the device;

FIG. 6 is a side elevational view of the stir stick handle engaged with a conventional wooden stir stick;

FIG. 7 is a plan view of the device as shown in FIG. 6; and

FIG. 8 is an exploded perspective view of the stir stick and stir stick handle shown in FIGS. 6 and 7.

### DESCRIPTION OF RELATED ART

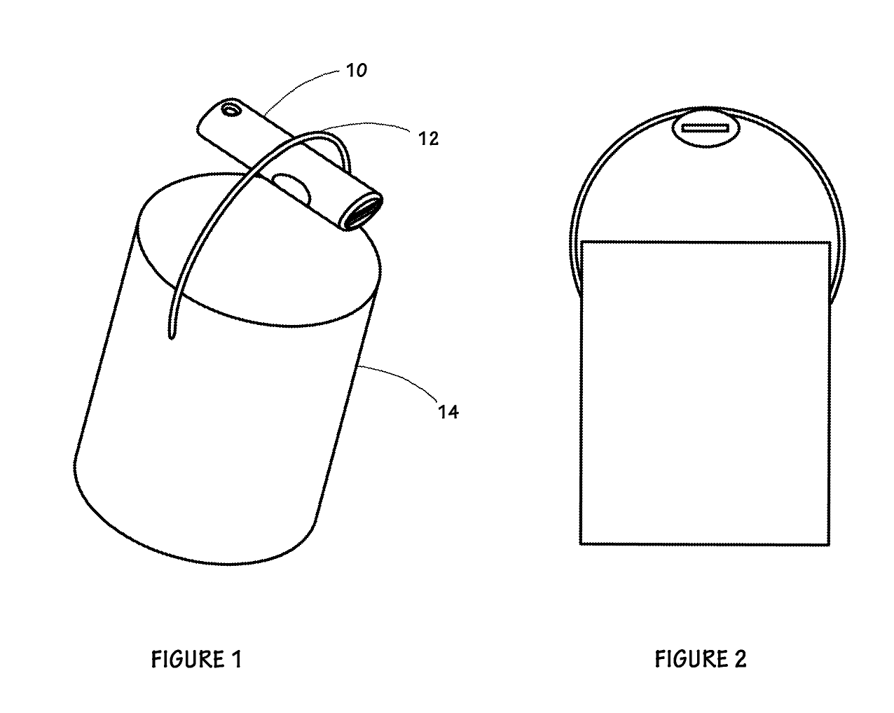

Referring now to the drawings in detail and initially to FIGS. 1 and 2, the stir stick handle 10 of the present invention is illustrated, without a stick secured in it, engaged (as described hereinafter) with a conventional carrying bail 12 of a paint can 14. By engaging the handle 10 transversely to the bail a wide and comfortable hand grip is provided to facilitate—and make more comfortable for the hand—transport of the can.

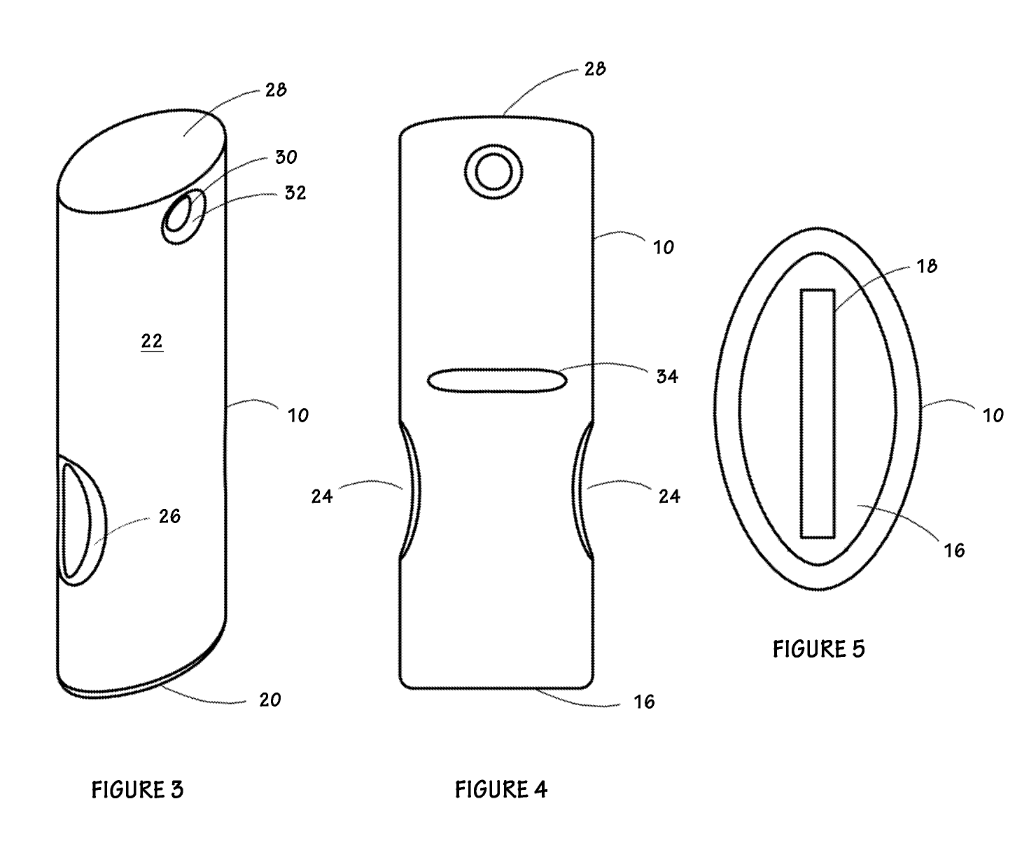

Referring FIGS. 3-5, the stir stick handle 10 is formed as a generally elongated body having an oval cross section. One end thereof 16, has a rectangular slot 18 formed therein which serves as the opening for an internal chamber which is adapted to receive the end of a convention paint stir stick. As illustrated in FIGS. 3 and 5, the periphery 20 of end 16 may be mitered for decorative purposes and to avoid the presence of a sharp corner.

The peripheral surfaces 22 of handle 10 has arcuate recesses 24 formed therein which join the surface 22 at mitered oval edges 26. Like the similar recess formed in the edges of conventional stir sticks these recesses allow for a better, more comfortable grip of the handle by the user for stirring paint or the like. The recesses are preferably formed at the ends of the long cross-sectional axis of the oval handle, closer to the end 16 of the handle, than to the opposite closed end 28 thereof.

Handle 10 has a through hole 30 formed therein, having a mitered edge 32, to allow the insertion of a string or thong of leather to hang the handle for storage if desired. Preferably handle 10 is formed as a single body by injection or rotary molding or in any other conventional manner, of a thermoplastic material. That material preferably has a Shore hardness of about 45 with some flexibility.

As seen in FIG. 4 a groove 34 is formed in the handle surface 22 parallel to the long axis of the handle's oval cross-section about in the middle of the handle between ends 16 and 28. When handle 10 is used as shown in FIGS. 1 and 2 the can bail 12 is placed in the groove 34, which prevents the bail from sliding on handle 10, and thus the handle can be grasped with the bail under the palm of the hands and handle 10 comfortably located in the fingers. The ergonomic oval shape of the handle improves user comfort.

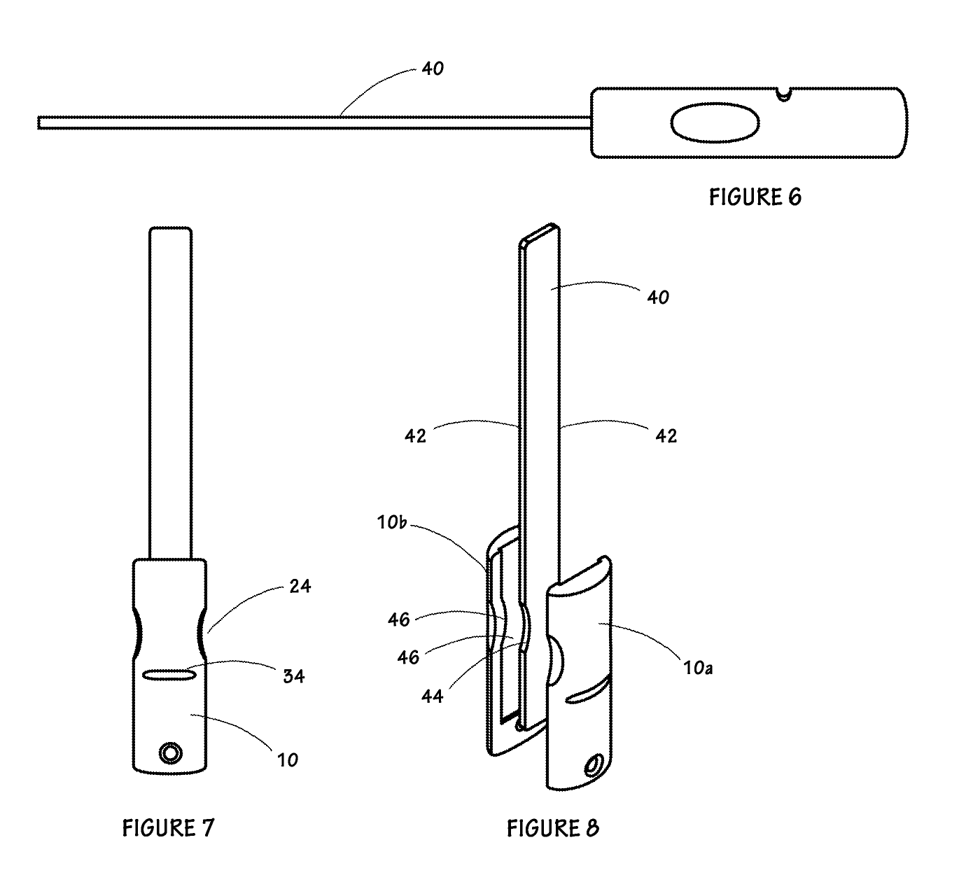

FIGS. 6-8 illustrate how handle 10 is used with a conventional wooden painter's stir stick. As seen in FIG. 8, wherein the handle 10 is shown separated into two parts and exploded for clarity, a conventional wood or plastic stir stick 40 is formed as a long thin rectangular body having short or thin side edges 42 which have recesses 44 (only one of which is seen in FIG. 6) for facilitating gripping of the stick. The end of the stick with the recess is inserted through the opening 18 of handle 10 into the interior chamber 46 formed in the handle.

As illustrated in FIG. 8 the sides of the chamber have curved edges 46 to mate with the recesses 46. The dimensions of the chamber 46 are essentially identical to the size of the stick end inserted in it so as to frictionally, but removably, hold the stick in the handle.

Given the use of a thermoplastic of Shore hardness 45 (e.g. urethane rubber) it is contemplated that the device of the present invention can be made by injection molding with a painter's stir stick inserted in the mold prior to injection of the thermoplastic. Once the thermoplastic is hardened it is sufficiently flexible to allow the stir stick to be withdrawn after use and another stick inserted. At this Shore hardness the stir stick can be removed with just the thumb and forefinger so that a paint-covered stick need not be grasped with the entire hand.

As seen in FIG. 6 the oval shape of the handle allows the stick to lie flat on a support surface with the stick above the surface so that it will not stick to the support surface if it is covered with paint. In addition the wide surface formed by the oval shape allows room on the handle for brand labeling or even molding of a brand into the handle itself.

While the present invention has been described herein with respect to the preferred embodiments, it is to be understood that the invention is not limited to those preferred embodiments and that various changes and modifications can be effected therein by those skilled in the art and remain within the scope and sprit of the invention.

What is claimed is:

1. A handle for a stir stick comprising a body having first and second ends, an opening formed in one of said ends, and a recess formed in the body in communication with the opening for receiving the end of a stir stick; said opening and recess being dimensioned to frictionally and removably engage an end of a stir stick inserted therein.

2. A handle as defined in claim 1 wherein said body has an oval cross section transverse to the recess.

3. A handle as defined in claim 1 wherein said body has recesses formed in its peripheral surface for facilitating manual grasping of the handle.

4. A handle as defined in claim 1 wherein the body has a groove formed on its surface substantially midway between said first and second ends and transverse to the recess for receiving the bail of a can to enable lifting of a can with the handle.

5. A handle as defined in claim 3 wherein said recesses are located at the ends of the long axis of the oval cross-section.

6. A handle as defined in claim 5 wherein the body has a groove formed on its surface substantially midway between said first and second ends and transverse to the recess for receiving the bail of a can to enable lifting of a can with the handle.

7. A handle as defined in claim 6 wherein said opening is formed in the first end of the body and a hole is formed in the body adjacent its second end in the direction of the short axis of the oval cross section.
